(19) United States
(12) Patent Application Publication
(10) Pub. No.: US 2021/0306098 A1
(43) Pub. Date: Sep. 30, 2021

(54) Communication Method and System

(71) Applicant: HARMAN INTERNATIONAL INDUSTRIES, INCORPORATED, STAMFORD, CT (US)

(72) Inventors: Guoxia Zhang, Shanghai (CN); Qingshan Zhang, Shanghai (CN); Zeng Yang, Shanghai (CN)

(21) Appl. No.: 16/465,766

(22) PCT Filed: Dec. 2, 2016
(86) PCT No.: PCT/IB2016/057295

§ 371 Date: May 31, 2019

(51) Int. Cl. H04L 1/00; H04L 5/00

(52) U.S. Cl. CPC H04L 1/0076; H04L 5/0053; H04L 1/0009

(57) ABSTRACT

A communication method and system for reducing computational overhead by obtaining N native data packets; obtaining M linearly independent coefficient vectors; encoding the N native data packets using the M linearly independent coefficient vectors respectively, to obtain M encoded data packets; and sending, through a network, at least one of the N native data packets and the M encoded data packets together, where N≥1 and M≥1.

### TECHNICAL FIELD

The present disclosure generally relates to communication method and system based on network coding.

### BACKGROUND

Network coding has emerged as an approach to the operation of communication networks, especially wireless networks. In this scheme, a network coding layer is embedded below Transmission Control Protocol (TCP) layer and above Internet Protocol (IP) layer on a source side or a receiver side to improve the capacity and efficiency of network transmissions. However, the computational overhead of the network coding layer is high.

### SUMMARY

In one embodiment, a communication method is provided. The method may include: obtaining N native data packets; obtaining M linearly independent coefficient vectors; encoding the N native data packets using the M linearly independent coefficient vectors respectively, to obtain M encoded data packets; and sending, through a network, at least one of the N native data packets and the M encoded data packets together, where N≥1 and M≥1.

In some embodiments, M may be determined based on a packet loss rate of the network and N.

In some embodiments, each of the data packets sent out through the network may have a header which contains a piece of information indicating whether the data packet is an encoded data packet or a native data packet.

In some embodiments, the M linearly independent coefficient vectors may be obtained from a look up table based on N and M.

In some embodiments, at least one of the M encoded data packets may have a header which contains a piece of information indicating N and M.

In some embodiments, each of the M encoded data packets may have a header which contains a sequence number of the encoded data packet.

In one embodiment, a communication method is provided. The method may include: receiving, through a network, R encoded data packets and S native data packets, where the R encoded data packets are generated based on N native data packets, and the N native data packets include the S native data packets; obtaining R linearly independent coefficient vectors; and decoding the R encoded data packets using the R linearly independent coefficient vectors and the S native data packets to obtain the N native data packets.

In some embodiments, each of the data packets received through the network may have a header which contains a piece of information indicating whether the data packet is an encoded data packet or a native data packet.

In some embodiments, at least of one of the R encoded data packets may have a header which contains a piece of information indicating N and M, M stands for the total number of encoded data packets which are generated based on the N native data packets, and the R linearly independent coefficient vectors may be obtained from a look up table based on N and M.

In some embodiments, each of the R encoded data packets may have a header which contains a sequence number of the encoded data packet, and the R linearly independent coefficient vectors may be selected based on N, M and sequence numbers of the R encoded data packets.

In one embodiment, a communication system is provided. The communication system may include a transceiver and a processing device configured to: obtain N native data packets; obtain M linearly independent coefficient vectors; encode the N native data packets using the M linearly independent coefficient vectors respectively, to obtain M encoded data packets; and control the transceiver to send, through a network, at least one of the N native data packets and the M encoded data packets together, where N≥1 and M≥1.

In some embodiments, M may be determined based on a packet loss rate of the network and N.

In some embodiments, each of the data packets sent out through the network may have a header which contains a piece of information indicating whether the data packet is an encoded data packet or a native data packet.

In some embodiments, the M linearly independent coefficient vectors may be obtained from a look up table based on N and M.

In some embodiments, at least one of the M encoded data packets may have a header which contains a piece of information indicating N and M.

In some embodiments, each of the M encoded data packets may have a header which contains a sequence number of the encoded data packet.

In one embodiment, a communication system is provided. The system may include a transceiver and a processing device configured to: after the transceiver receives, through a network, R encoded data packets and S native data packets, obtain R linearly independent coefficient vectors, where the R encoded data packets are generated based on N native data packets, and the N native data packets include the S native data packets; and decode the R encoded data packets using the R linearly independent coefficient vectors and the S native data packets to obtain the N native data packets.

In some embodiments, each of the data packets received through the network may have a header which contains a piece of information indicating whether the data packet is an encoded data packet or a native data packet.

In some embodiments, at least of one of the R encoded data packets may have a header which contains a piece of information indicating N and M, M stands for the total number of encoded data packets which are generated based on the N native data packets, and the R linearly independent coefficient vectors may be obtained from a look up table based on N and M.

In some embodiments, each of the R encoded data packets may have a header which contains a sequence number of the encoded data packet, and the R linearly independent coefficient vectors may be selected based on N, M and sequence numbers of the R encoded data packets.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a schematic flow chart of a communication method according to one embodiment;

FIG. 2 schematically illustrates a network coding protocol stack according to one embodiment;

FIG. 3 schematically illustrates contents of a header 300 according to one embodiment;

FIG. 4 schematically illustrates contents of a header 400 according to one embodiment;

FIG. 5 schematically illustrates contents of a header 500 according to one embodiment; and

FIG. 6 illustrates a schematic block diagram of a communication system according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

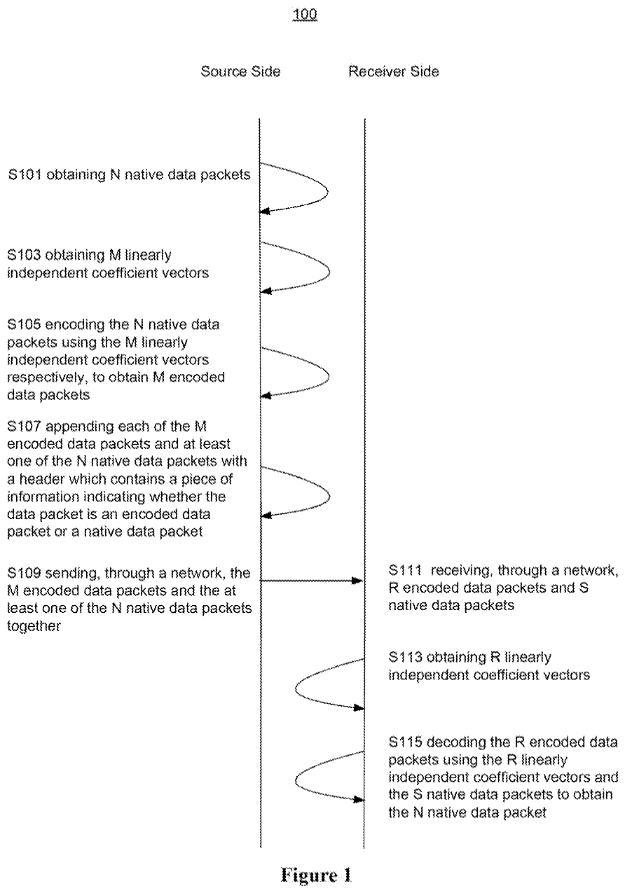

FIG. 1 illustrates a schematic flow chart of a communication method 100 according to one embodiment.

In S101, obtaining N native data packets.

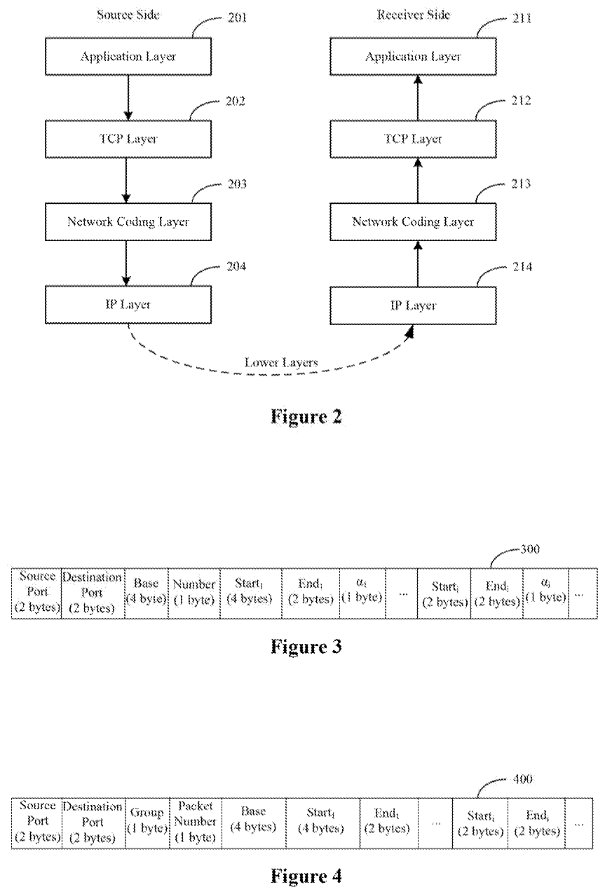

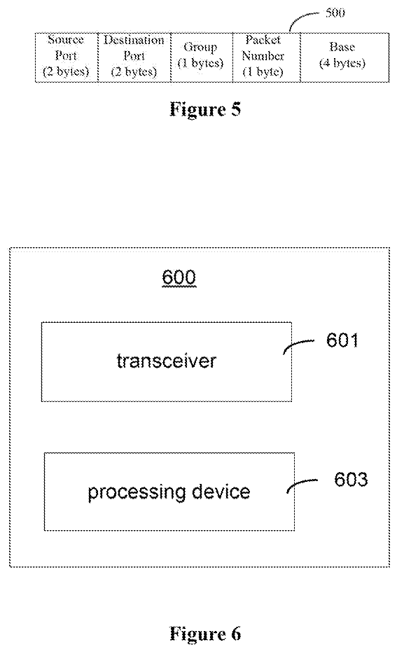

FIG. 2 schematically illustrates a network coding protocol stack according to one embodiment. Referring to FIG. 2, the network coding protocol stack on a source side includes an application layer 201, a Transmission Control Protocol (TCP) layer 202, a network coding layer 203 and an Internet Protocol (IP) layer 204. The network coding layer 203 is embedded below the TCP layer 202 and above the IP layer 204. In some embodiments, the network coding layer 203 on the source side may receive the N native data packets from the TCP layer 202. In some embodiments, the network coding layer 203 on the source side may buffer the N native data packets into an encoding buffer.

In S103, obtaining M linearly independent coefficient vectors.

In some embodiments, the M linearly independent coefficient vectors may be generated based on a random number generation algorithm. For example, elements of a coefficient vector are randomly selected from a field with a size of 256, and linearly independent estimation processes may be performed on the random generated coefficient vectors.

In some embodiments, the M linearly independent coefficient vectors may be selected from a look up table based on N and M. The look up table may be stored in the source side. The look up table includes a plurality of sets of linearly independent coefficient vectors. Each set of linearly independent coefficient vectors corresponds to a different pair of native data packet quantity and encoded data packet quantity. An example of the look up table is shown in Table 1. For example, if M=M₄ and N=N₃, M linearly independent coefficient vectors in a set of S43 may be selected. Because the M linearly independent coefficient vectors are selected from the look up table, linearly independent estimation processes performed on the coefficient vectors are not needed. Therefore, the computational overhead on the source side is reduced.

TABLE 1

| | N₁ | N₂ | N₃ | . . . | Nⱼ |
|---|---|---|---|---|---|
| M₁ | S11 | S12 | S13 | . . . | S1j |
| M₂ | S21 | S22 | S23 | . . . | S2j |
| M₃ | S31 | S32 | S33 | . . . | S3j |
| M₄ | S41 | S42 | S43 | . . . | S4j |
| . . . | . . . | . . . | . . . | . . . | . . . |
| Mᵢ | Si1 | Si2 | Si3 | | Sij |

In S105, encoding the N native data packets using the M linearly independent coefficient vectors respectively, to obtain M encoded data packets.

In some embodiments, each of the M encoded data packets is a linear combination of the N native data packets based on a corresponding linearly independent coefficient vector of the M linearly independent coefficient vectors. For example, each of the M encoded data packets are obtained by Equation (1):

q=Σᵢ₌₁^{i=N}αᵢpᵢ Equation (1)

where q represents one of the M encoded data packets, pᵢ represents an i^{th} data packet of the N native data packets, and αᵢ represents an i^{th} element of a corresponding coefficient vector.

In S107, appending each of the M encoded data packets and at least one of the N native data packets with a header which contains a piece of information indicating whether the data packet is an encoded data packet or a native data packet.

The M encoded data packets and the at least one of the N native data packets may be sent out through a network in subsequent steps. Due to the random packet loss of the network, the total number of data packets sent out should be chosen carefully, so that the receiver side can receive enough data packets to obtain the N native data packets. In some embodiments, the number of the data packets sent out may be greater than N. In some embodiments, the number of the data packets sent out may be determined based on a packet loss rate of the network and N.

In some embodiments, the number of the data packets sent out may be calculated by Equation (2):

K=N/(1−Pₑ) Equation (2)

where K represents the number the data packets sent out, and Pₑ represents the packet loss rate of the network.

After the number of the data packets sent out is determined, each of the data packets sent out may be appended with a header which contains a piece of information indicating whether the data packet is an encoded data packet or a native data packet.

FIG. 3 schematically illustrates a header 300 according to one embodiment. In some embodiments, the header 300 may be appended to each of the data packets sent out. Referring to FIG. 3, the header 300 includes a 2-bytes “Source Port” field, a 2-bytes “Destination Port” field, a 4-byte “Base” field, and a 1-byte “Number” field. The “Source Port” field and the “Destination Port” are needed for the receiver side to identify which TCP connection the data packet corresponds to. In some embodiments, the “Source Port” and the “Destination Port” are taken out of a TCP header of a corresponding data packet and are included in the header 300. The “Base” field indicates a TCP byte sequence number of a first data packet that has not been acknowledged. In some embodiments, the “Base” field may be used by the source side or the receiver side to decide which data packet can be safely dropped from its buffer without affecting reliability. The “Number” field indicates the total number of the native data packets, that is, N.

The header 300 may further include N “Startᵢ” fields, N “Endᵢ” fields and N “αᵢ” fields. For encoding operations on the source side, the N native data packets are adjusted to have a fixed packet length. The “Startᵢ” field may indicate the starting byte of an i^{th} data packet in a corresponding fixed-length data packet, and the “Endᵢ” field may indicate the last byte of the i^{th} data packet in the corresponding fixed-length data packet. The “αᵢ” field represents an i^{th} coefficient used for the i^{th} data packet. For the encoded data packets, the n “αᵢ” fields represent a corresponding coefficient vector of an encoded data packet. For the native data packets, the “αᵢ” field of an i^{th} native data packet is set to 1, and other “α” fields of the i^{th} native data packets is set to 0. Therefore, the n “αᵢ” fields of the header 300 can indicate whether the data packet is an encoded data packet or a native data packet.

In some embodiments, in the case of the M linearly independent coefficient vectors are selected from a look up table based on N and M, a header 400, as shown in FIG. 4, may be appended to each of the M encoded data packets sent out, and a header 500, as shown in FIG. 5, may be appended to each of the native data packets sent out.

Referring to FIG. 4, the header 400 includes a 1-byte “Group” field and a 1-byte “Packet Number” field. The “Group” field may be used to identify the specific combination of N and M. For example, a 4-bits sub-field of the “Group” field is used to represent N, and the other 4-bits sub-field of the “Group” field is used to represent M. The “Packet Number” field is used to identify a sequence number of the corresponding data packet. The header 400 further includes a 2-bytes “Source Port” field, a 2-bytes “Destination Port” field, a 4-bytes “Base” field, N “Startᵢ” fields and N “Endᵢ” fields. The “Source Port” field, “Destination Port” field, “Base” field, “Startᵢ” fields and “Endᵢ” fields may have the same meaning with the header 300.

Referring to FIG. 5, the header 500 includes a 2-bytes “Source Port” field, a 2-bytes “Destination Port” field, a 1-byte “Group” field, a 1-byte “Packet Number” field and a 4-bytes “Base” field. The “Source Port” field, “Destination Port” field, “Group” field and “Packet Number” field have the same meaning with the header 400. Compared with the header 400, the header 500 doesn't have the N “Startᵢ” fields and the N “Endᵢ” fields. Therefore, the header 400 and the header 500 can be used to determine whether the data packet is an encoded data packet or a native data packet.

In S109, sending, through the network, the M encoded data packets and the at least one of the N native data packets together.

As shown in FIG. 2, in some embodiments, the network coding layer 203 may send the M encoded data packets and the at least one of the N native data packets to the IP layer 204, and the IP layer 204 may send the M encoded data packets and the at least one of the N native data packets through lower layers.

At the receiver side, instead of the N native data packets, encoded data packets and native data packets may be received.

In S111, receiving, through the network, R encoded data packets and S native data packets.

As shown in FIG. 2, the network coding protocol stack on the receiver side may include an application layer 211, a TCP layer 212, a network coding layer 213 and an IP layer 214. The network coding layer 213 is embedded below the TCP layer 212 and above the IP layer 214 on the receiver side. In some embodiments, the IP layer 214 on the receiver side may receive the R encoded data packets and the S native data packets from lower layers, and send the R encoded data packets and the S native data packets to the network coding layer 213. In some embodiments, the network coding layer 213 on the receiver side may buffer the R encoded data packets and the S native data packets into a decoding buffer.

Because the random packet loss of the network, maybe not all of the M encoded data packets and the at least one native data packets sent by the source side can be received by the receiver side. In some embodiments, R of the M encoded data packets and S of the at least one of the N native data packets are received by the receiver side. Until the number of the data packets in the decoding buffer reaches N, the N native data packets can be obtained by decoding the data packets in the decoding buffer. That is, a sum of the R encoded data packets and the S native data packets should be equal to or greater than N.

In S113, obtaining R linearly independent coefficient vectors.

The network coding layer 213 can determine whether the data packets received are encoded data packets or native data packets based on their headers. In some embodiments, each of the data packets received is appended with a header 300 as shown in FIG. 3. The network coding layer can determine whether a data packet received is an encoded data packet or a native data packet based on the n “αᵢ” fields in its header. In some embodiments, a pan of the data packets received are appended with a header 400 as shown in FIG. 4, and a part of the data packets received are appended with a header 500 as shown in FIG. 5. The network coding layer can determine whether a data packet is an encoded data packet or a native data packet based on whether its header contains N “Startᵢ” fields and N “Endᵢ” fields.

In some embodiments, if each of the R encoded data packets is appended with the header 300, the R linearly independent coefficient vectors can be obtained from the “α” fields in the R headers of the R encoded data packets.

In some embodiments, if each of the R encoded data packets is appended with the header 400, the network coding layer may unpack the header 400 to obtain N and M in the “Group” field. In some embodiments, a look up table, which is the same as the look up table in the source side, is stored in the receiver side. The look up table includes a plurality of sets of linearly independent coefficient vectors. Each set of linearly independent coefficient vectors corresponds to a different pair of N and M. The network coding layer may search the look up table to obtain a set of linearly independent coefficient vectors based on N and M.

Moreover, as shown in FIG. 3, the header 400 of each of the R encoded data packets may include a “Packet Number” field. The network coding layer may obtain R sequence numbers of the R encoded data packets from the “Packet Number” fields. Then, the network coding layer may further select R linearly independent coefficient vectors from the selected set of linearly independent coefficient vectors based on the R sequence numbers.

In S115, decoding the R encoded data packets using the R linearly independent coefficient vectors and the S native data packets to obtain the N native data packets.

In some embodiments, the R linearly independent coefficient vectors and the S native data packets may be put into a decoding coefficient matrix. A Gaussian elimination may be performed on the decoding coefficient matrix to decode the R encoded data packets, so that adjusted data packets with a fixed-length may be obtained. As shown in FIG. 3, based on the “Startᵢ” fields and the “Endᵢ” fields in the header, the first byte and the last byte of the i^{th} native data packet in the corresponding adjusted data packet may be determined, and the i^{th} native data packet can be obtained.

Thereafter, as shown in FIG. 2, the network coding layer 213 on the receiver side may send the N native data packets to the TCP layer 212 based on information of the “Destination Port” field in the header.

As described above, because the source side sends both of native data packets and encoded data packets to the receiver side, encoding operations on the source side and decoding operations on the receiver side can be reduced. Therefore, computation overhead on both of the source side and the receiver side can be reduced. Furthermore, because the header 400 and the header 500 don't contain the coefficient vectors, the network overhead can be reduced.

According to one embodiment, a communication system is provided. The communication system may be disposed at a source side or a receiver side in a network. FIG. 4 illustrates a schematic block diagram of the communication system 600 according to one embodiment. The communication system 600 may includes a transceiver 601 and a processing device 603.

If the communication system 600 is disposed at a source side. The processing device 603 may be configured to: obtain N native data packets; obtain M linearly independent coefficient vectors; encode the N native data packets using the M linearly independent coefficient vectors respectively, to obtain M encoded data packets; and control the transceiver 601 to send, through a network, at least one of the N native data packets and the M encoded data packets together, where N≥1 and M≥1. Detail configurations of the processing device 603 may be obtained by referring detail descriptions in S101 to S109.

If the communication system 600 is disposed at a receiver side. The processing device 603 may be configured to: after the transceiver 601 receives, through a network, R encoded data packets and S native data packets, obtain R linearly independent coefficient vectors, where the R encoded data packets are generated based on N native data packets, and the N native data packets include the S native data packets; and decode the R encoded data packets using the R linearly independent coefficient vectors and the S native data packets to obtain the N native data packets. Detail configurations of the processing device 603 may be obtained by referring detail descriptions in S111 to S115.

There is little distinction left between hardware and software implementations of aspects of systems; the use of hardware or software is generally a design choice representing cost vs. efficiency tradeoffs. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A communication method, comprising:
obtaining N native data packets;
obtaining M linearly independent coefficient vectors;
encoding the N native data packets using the M linearly independent coefficient vectors respectively, to obtain M encoded data packets; and
sending, through a network, at least one of the N native data packets and the M encoded data packets together, where N≥1 and M≥1.

2. The method according to claim 1, wherein M is determined based on a packet loss rate of the network and N.

3. The method according to claim 1, wherein each of the data packets sent out through the network has a header which contains a piece of information indicating whether the data packet is an encoded data packet or a native data packet.

4. The method according to claim 1, wherein the M linearly independent coefficient vectors are obtained from a look up table based on N and M.

5. The method according to claim 4, wherein at least one of the M encoded data packets has a header which contains a piece of information indicating N and M.

6. The method according to claim 4, wherein each of the M encoded data packets has a header which contains a sequence number of the encoded data packet.

7. A communication method, comprising:
receiving, through a network, R encoded data packets and S native data packets, where the R encoded data packets are generated based on N native data packets, and the N native data packets comprise the S native data packets;
obtaining R linearly independent coefficient vectors; and
decoding the R encoded data packets using the R linearly independent coefficient vectors and the S native data packets to obtain the N native data packets.

8. The method according to claim 7, wherein each of the data packets received through the network has a header which contains a piece of information indicating whether the data packet is an encoded data packet or a native data packet.

9. The method according to claim 7, wherein at least of one of the R encoded data packets has a header which contains a piece of information indicating N and M, M stands for the total number of encoded data packets which are generated based on the N native data packets, and the R linearly independent coefficient vectors are obtained from a look up table based on N and M.

10. The method according to claim 9, wherein each of the R encoded data packets has a header which contains a sequence number of the encoded data packet, and the R linearly independent coefficient vectors are selected based on N, M and sequence numbers of the R encoded data packets.

11. A communication system, comprising a transceiver and a processing device configured to:
obtain N native data packets;
obtain M linearly independent coefficient vectors;
encode the N native data packets using the M linearly independent coefficient vectors respectively, to obtain M encoded data packets; and
control the transceiver to send, through a network, at least one of the N native data packets and the M encoded data packets together, where N≥1 and M≥1.

12. The system according to claim 11, wherein M is determined based on a packet loss rate of the network and N.

13. The system according to claim 11, wherein each of the data packets sent out through the network has a header which contains a piece of information indicating whether the data packet is an encoded data packet or a native data packet.

14. The system according to claim 11, wherein the M linearly independent coefficient vectors are obtained from a look up table based on N and M.

15. The system according to claim 14, wherein at least one of the M encoded data packets has a header which contains a piece of information indicating N and M.

16. The system according to claim 14, wherein each of the M encoded data packets has a header which contains a sequence number of the encoded data packet.

17. (canceled)

18. (canceled)

19. (canceled)

20. (canceled)
